(19) United States
(12) Patent Application Publication
(10) Pub. No.: US 2006/0277277 A1
(43) Pub. Date: Dec. 7, 2006

(54) Method of automatically caching WAP web pages and a mobile communications device for the same

(75) Inventors: Assaf Landschaft, Munich (DE); Gal Wohlstadter, Munich (DE); Gil Wohlstadter, Munich (DE)

Correspondence Address: HITT GAINES, PC;AGERE SYSTEMS INC., PO BOX 832570, RICHARDSON, TX, 75083, US

(73) Assignee: Agere Systems Inc., Allentown, PA (US)

(21) Appl. No.: 11/143,910

(22) Filed: Jun. 2, 2005

(51) Int. Cl. G06F 15/177

(52) U.S. Cl. 709/220; 707/3; 709/204; 455/422.1

(57) ABSTRACT

A method of, and a device for, storing and retrieving information with a mobile communications device. In one embodiment, the method includes automatically downloading information from a data source to a storage means coupled to a mobile communications device while the device is connected to a communications network; and retrieving the information from the storage means when the mobile communications device is disconnected from the communications network and displaying such information to a user.

### TECHNICAL FIELD OF THE INVENTION

The present invention is directed, in general, to a mobile communications device and, more specifically, to a method of storing and retrieving web pages adapted to Wireless Application Protocol (WAP) standards with a mobile communications device that stores information when the mobile communications device is online to be retrieved when offline

### BACKGROUND OF THE INVENTION

The Internet has increasing become the primary source of information for a number of users of mobile communications devices. As the number of users increase, a premium has been placed on reliable and user friendly Internet access devices. This is particularly so for an increasing number of people who regularly rely on Internet access in their occupations to retrieve information.

Increased Internet usage continues to cause traffic congestion, particularly on popular web sites. Although bandwidth availability has continuously increased, traffic congestion problems have outpaced this increased bandwidth availability.

A favored technique to mitigate access problems caused by traffic congestion is to utilize caching techniques with respect to certain Internet applications. In U.S. Patent Application No. 20030182357 entitled CLIENT-SIDE CACHING OF PAGES WITH CHANGING CONTENT, Chess, Brian, et al. (Chess), a method is disclosed to improve access to Internet content by using caching techniques to cache web pages every time they are accessed by a user. A web page is only downloaded and cached when the most recent version of the web page is not already cached, thereby significantly reducing the time needed to display a requested web page. To check on whether the most recent version of a web page is in the cache, a script is provided by the web server. The web server appends a previously established cookie value to the URL originally requested and then requests the URL again based on an appended cookie value, the value of which is computed based on the time of the last page modification.

In addition to regular personal computers, the Internet is also regularly accessed with mobile communications devices such as, for instance, the seemingly ubiquitous mobile or cellular telephone. In order for web pages to be displayed on the small display or screen of a mobile telephone or other mobile communications device, the web pages are usually accordingly adapted, such as, for example, utilizing Wireless Application Protocol (WAP) standards.

When mobile communications devices are used to access the Internet, an additional problem to contend with is that of temporary connection loss. For example, when a mobile communications device is being used on a subway, the device will typically lose connection with its applicable communications network.

A caching method similar to that described in Chess is not suitable for mobile communication devices; because the method described therein is based on being continuously connected to a communications network. In addition, during periods of mobile communications device connection loss, only the web page cache version of the last access to that web page is available. The mobile communications device user has no way to check on whether the cache version of the web page is up-to-date and, because of the connection loss, a newer or later version of the web page can not be downloaded. This leaves the user in the position of having to rely on significantly outdated information, until a connection can be reestablished. In the case of most mobile communications devices, it is generally impossible to cache all the accessed information because the device data storage capacity is generally insufficient.

Accordingly, what is needed in the art is a new and improved approach to providing information, especially Internet content, to a user of a mobile communications device via a communication network.

### SUMMARY OF THE INVENTION

To address the above-discussed deficiencies of the prior art, the present invention provides a method of, and a device for, storing and retrieving information with a mobile communications device. In one embodiment, the method includes automatically downloading information from a data source to a storage means coupled to a mobile communications device while the device is connected to a communications network; and retrieving the information from the storage means when the mobile communications device is disconnected from the communications network and displaying such information to a user.

Thus the present invention beneficially provides a method and device for a user of a cellular phone, or other mobile communications device, to retrieve information that is current as of a time determined by the user or based on the user's profile and view it when the cellular phone or other mobile communications device is not connected to a communications network.

In one embodiment of the invention the data source is the Internet. Of course the data source could be a company wireless wide area network or other similar type of data source and still be within the intended scope of the present invention. The option to select from different data sources is provided by another embodiment which provides for a data source pre-selected by the user.

A particularly useful embodiment of the present invention provides for the downloading of data to be in accordance with Wireless Application Protocol (WAP) standards. In another embodiment, the downloading is at a plurality of pre-defined time intervals which can be advantageously selected by the user. Another advantageous embodiment, hereinafter explained in more detail, provides for the downloading to be on a user-defined schedule specifying at least one data source and at least one retrieval time.

In still another embodiment of the invention the downloading is determined pursuant to an access profile stored in the storage means, wherein the access profile is determined by monitoring data sources accessed by the user. The access profile is creating based on the data source addresses and the corresponding access times and/or access frequency by the user.

One embodiment of the mobile communications device provides for a (1) means for storing download parameters, where the parameters consist of information regarding at least one data source and at least one retrieval time and/or interval; (2) a means for storing information downloaded from the data source when the mobile communications device is connected to a communications network; and (3) a means for a user to retrieve the stored information when the mobile communications device is not connected to a communications network.

A particularly useful embodiment of the invention provides for the communications device to be adapted to communicate with a communication network in accordance with GSM and/or UMTS standards. Still another embodiment provides for a means for transmitting and/or receiving data with a packet switched service or with a packet data protocol addressed service selected from the group consisting of GPRS, HSCSD and/or EDGE.

Another embodiment of the invention provides for the downloading to be in accordance with Wireless Application Protocol (WAP) standards. A further embodiment provides for the device to include a means for monitoring time. The widest and most general use of the device will include an embodiment wherein the data source is the Internet. The device will also include an embodiment wherein the download parameters are pre-selectable by the user. A useful embodiment of the invention will provide for the download parameters to consist of a user-defined schedule where the schedule consists of information on at least one data source and at least one corresponding retrieval time.

In yet still another embodiment of the invention, a download means will be included for automatically downloading information based on download parameters. This automatic download will, in one embodiment, be based on the download parameters adapted to download information at pre-defined time intervals. Another aspect of the invention provides for a control unit in the mobile communications device that is adapted to monitor user access to data sources and generate and store an access profile based on address information of the data sources and corresponding access times and/or access frequency of the user.

Another embodiment of the present invention provides for a mobile communications storage enabling device. This device will include a digital storage medium of electronically readable control instructions to enable a mobile communications device, associable with the storage enabling device, to automatically download, in accordance with predetermined parameters, information from a data source to a storage means coupled to the mobile communications device; and a retrieval and display means to enable a user to recover information from the storage means and display such information when the mobile communications device is disconnected from the communications network. A particularly useful embodiment of the mobile communications storage enabling device provides for the digital storage medium to be a microchip.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a method of storing and retrieving information with a mobile communications device in accordance with the present invention;

FIG. 2 illustrates a block diagram of a mobile communications device constructed in accordance with the present invention;

FIG. 3 illustrates a flow chart of a system for storing information on a mobile communications device in accordance with the present invention; and

FIG. 4 illustrates a flow chart of a system for retrieving information with a mobile communications device in accordance with the present invention.

### DETAILED DESCRIPTION

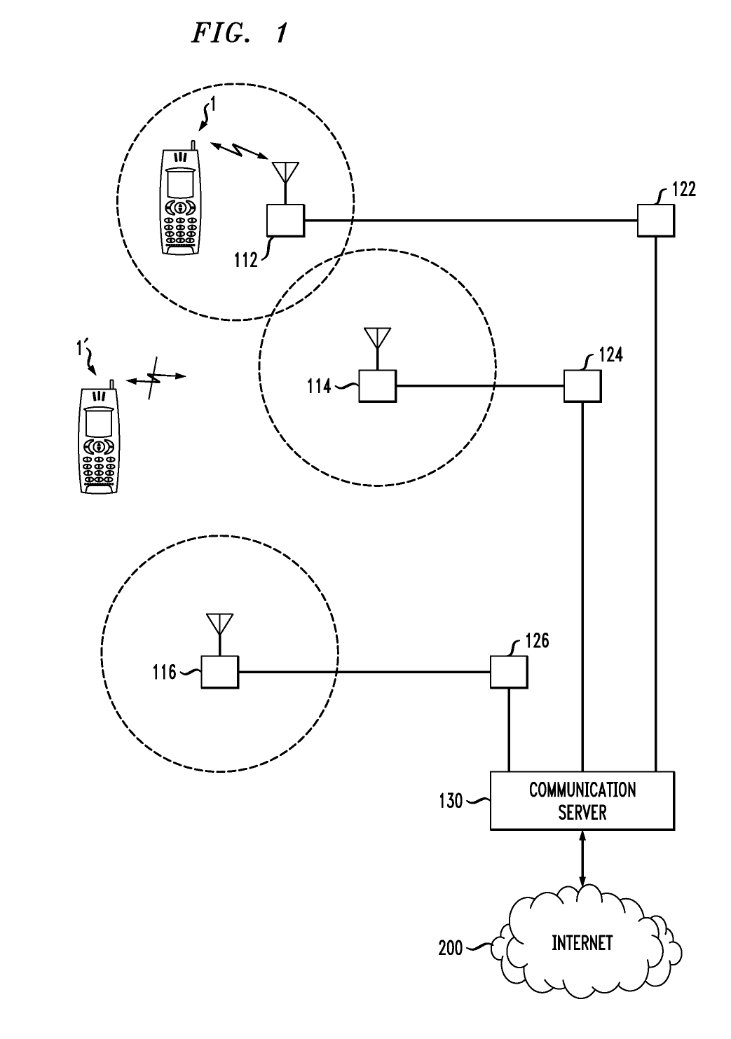

Initially turning to FIG. 1, illustrated is a method of storing and retrieving information with a mobile communications device 1 in accordance with the present invention. The present invention can be usefully employed when associated with a cellular or mobile telephone 1, as shown. FIG. 1 shows three base transceiving stations 112, 114, 116 that are, respectively, connected to three base station controllers 122, 124 and 126 that are, in turn, connected to a communication server 130, through which the Internet 200 is accessed. It is clear to those skilled in the pertinent art that the aforementioned components are merely an exemplary portion of a typical mobile telecommunications network. In addition to the components shown, a typical mobile telecommunications network will include a large number of each of the components illustrated as well as additional components, such as serving GPRS support nodes, gateway GPRS support nodes and/or gateway mobile switching centers, and so on.

When the mobile communications device 1, or cellular telephone, is within range of a base transceiving station 112, 114, 116 the Internet 200 is accessed through the mobile communication network. The mobile communications device is then able to download information from the Internet, such as web site pages compliant with WAP standards. When the mobile communication device 1′ is outside the range of the base transceiving stations 112, 114, 116, access to the Internet 200 will be interrupted. Thus, the present invention permits the user of a mobile communications device 1 to define parameters so that one or more Internet 200 pages will be downloaded in accordance with WAP standards and pre-cached so that the user can access them when his or her mobile communications device 1, such as a cell phone, has lost access to the communications network 100.

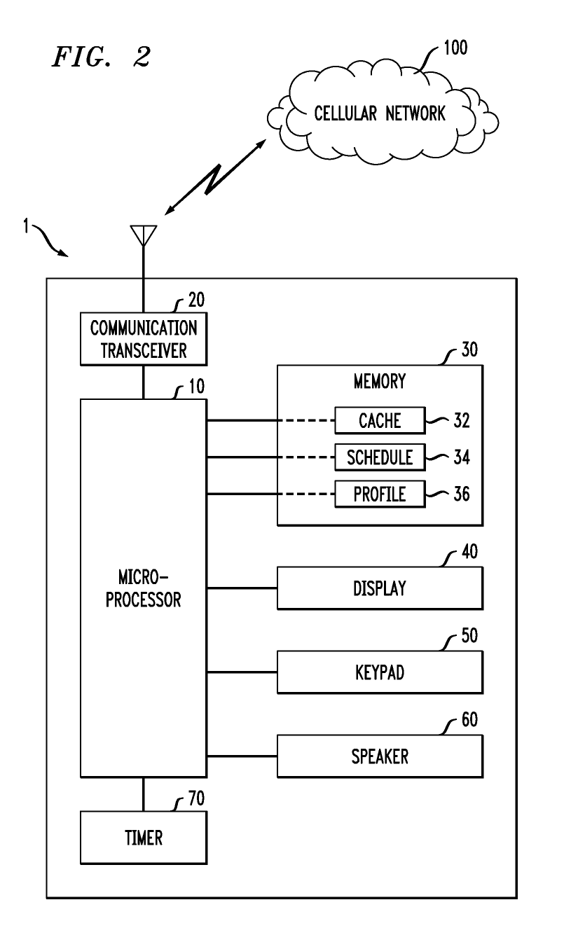

Turning now to FIG. 2, illustrated is a block diagram of a mobile communications device 1 constructed in accordance with the present invention. In this embodiment, pre-caching functionality is controlled by a software program stored in the memory 30, which software program is executed by a micro-processor 10. At least one data source and a pre-caching schedule of fixed download times and/or download intervals is entered by the user utilizing the mobile communications device 1 display 40, keypad 50 and speaker 60 as an interface. The scheduled download parameters are stored in a schedule portion 34 of the memory 30. Based on the stored schedule and utilizing a timer 70 for monitoring the time, information from a pre-selected data source, or sources, is downloaded and stored in a cache portion 32 of the memory 30. While downloading, the mobile communications device 1, in this case a cell phone, is connected to a cellular network 100 by means of a communications transceiver 20, which provides the necessary connection between the Internet 200 and the mobile communications device 1. When there is no connection between the Internet 200 and the mobile communications device 1 (generally because the connection between the cellular network 100 and the mobile communications device 1 is lost) a user can still retrieve information from the cache 32, with the currency of the information based on the stored schedule entered by the user.

Also illustrated is a portion of the memory 30 that is utilized for storing a user's access profile 36. This access profile consists of address information to access data sources utilized by the user and corresponding access times and/or frequency of access to such data sources by the user. This access profile 36 can also be used to determine information to be downloaded for pre-caching purposes. Thus, information can, alternatively, be downloaded from the Internet either based on a user's predetermined schedule 34 or on a user's profile 36.

Thus, the method described herein permits a user to pre-select at least one data source and automatically download information from that pre-selected data source at a predetermined time or times. The user specifies one or more WAP Internet web pages and pre-defines the desired download times, which times can be specified by specific times or by pre-defined time intervals. At these times or time intervals information will be automatically downloaded from the pre-selected data source, if the mobile communications device is connected to a communications network.

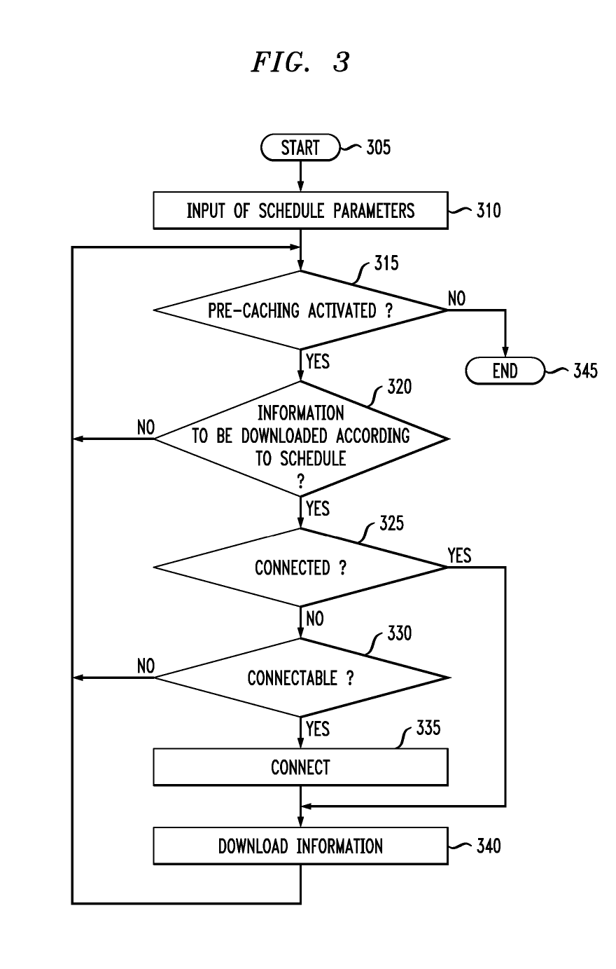

Turning now to FIG. 3, illustrated is a flow chart of a system for storing information on a mobile communications device in accordance with the present invention. The system commences with a start step 305. Next, in an input of schedule parameters step 310, information regarding scheduling parameters for caching is input by the user and stored in the memory of the mobile communication device. Next, in a pre-caching activated query 315, a determination is made whether or not the pre-caching functionality of the mobile communications device is activated 315. If the response to the pre-caching activated query 315 is negative or no, the system concludes with an end step 345.

If the response to the pre-caching activated query 315 is positive or yes, functionality of the system is activated and a loop is performed in which the system repeatedly queries whether information needs to be downloaded in accordance with a stored schedule 320. If the query is yes and information is scheduled to be downloaded, the system queries whether the mobile communications device is connected 325 to the communication network. If a connection is detected, the response is yes and the system proceeds to a download information step 340; whereupon, information is downloaded based on the predetermined schedule. If no connection is detected in the connected 325 step, the system queries whether the communications device is connectable 330, the response to which is based on the availability of a communications network. If a communications network is available, the response to the connectable query 330 is yes and connection with a communications network is established in a connect step 335. When the mobile communications device is connected, Internet information is downloaded in a download information step 340 in accordance with the predetermined schedule and stored. If the response to the connectable step 330 is no, the system restarts the loop by return to the pre-caching activated step 315.

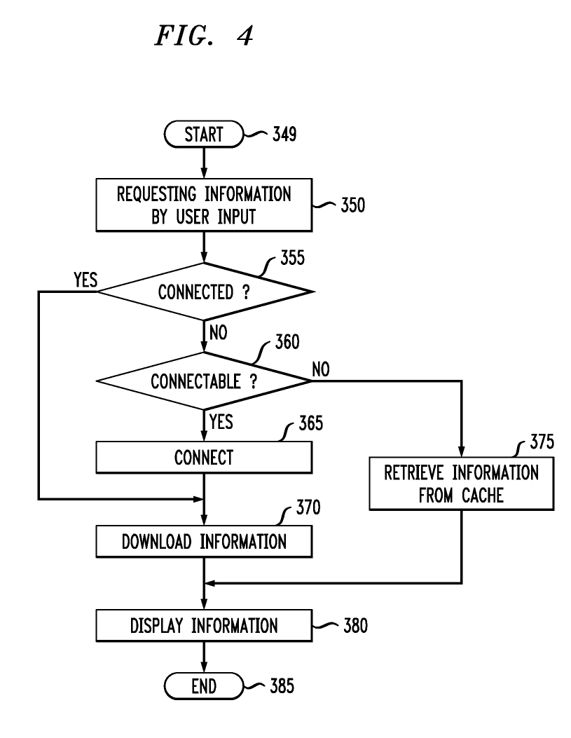

FIG. 4 illustrates a flow chart of a system for retrieving information with a mobile communications device in accordance with the present invention. The system commences with a start step 349. In a requesting information by user input step 350, the user requests information from the system. In response to this request, the system queries in a connected query 355 step, whether the mobile communications device is connected to a communications network. If the system is connected, the system proceeds to download information in a download information step 370. If, however, no connection is detected, the response to the query is no and a connectable 360 query is made. The system then determines the availability of a communications network and, if it is available, connection with the network is established in a connect step 365. After the mobile communications device is connected to the communications network, the requested information is downloaded in a download information 370 step and displayed to the user in a display information 380 step. If, however, the communications network is not available, the response to the connectable 360 query will be no and the system will retrieve the requested information from the cache memory in a retrieve information from cache 370 step. The information retrieved from the cache is then displayed to the user in a display information 380 step.

Thus the present invention enables a user to access some information even when a communications network connection is unavailable, such as when the user is on a subway or in an underground parking lot. The information cached can be based on a predetermined schedule selected by the user. Alternatively, or in addition to, the cached information can be based on the user's profiled usage of the mobile communications device. Based on this schedule, the mobile communication device will automatically download information from a data source via a communication network while connected to the communication network and store such information in a storage means, such as a cache, within the mobile communications device. Then, when a user wants to recover the relevant information and access to the data source is unavailable because the mobile communications device is disconnected from the communications network, the user can retrieve and review the stored information by means of a user interface with on mobile communications device.

Thus, the present invention permits continuous access to Internet resources by users of mobile communications devices, with the most current information available being no later than that last downloaded in accordance with a predetermined schedule. Information from the Internet can advantageously be recovered with a mobile communications device, such as a cell phone, by downloading data in accordance with WAP, such as that set forth in WAP standards 1.× or 2.0, with information typically being provided in a Wireless Markup Language (WML) format. Based on WAP 2.0, other formats are also supported, such as, for example, xHTML or script language.

Most people tend to have a cluster of favorite WAP supported Internet sites they periodically visit. For example, many business people check the stock market every day on the way to or from work. In certain situations, such as when the person is in a subway or a parking garage, a WAP Internet connection may not be available. Because the present invention provides a caching mechanism for surfing the web, the user can configure it by specifying the frequency and time for caching, so that stock market performance can be checked at any time or place with the results being current, if a communications network connection is available, or, if a connection is not available, current as of the last page automatically cached based on the user's preset instructions or profile. While performing its caching activity the mobile communication device accesses and caches web sites as a background activity when a connection is available. That is, the device visits the site and downloads the relevant pages so a user can browse such pages when he or she is offline.

The invention also provides for a method of creating a user profile. This method includes the steps of monitoring data sources accessed by a user and creating and storing an access profile comprising address information for the accessed data sources together with the corresponding access times and/or access frequencies. The system can then download information for pre-caching purposes based on this profile.

Preferably the mobile communication device will be adapted to communicate with a communication network according to GSM and/or UMTS standards. To download information, the mobile communications device will advantageously include means for transmitting and/or receiving data with a packet switched service or with a packet data protocol addressed service, in particular with GPRS, HSCSD and/or EDGE. For accessing Internet sites, the device will further advantageously include a means for the downloading of data according to WAP standards, in particular WAP 1.× or WAP 2.0.

Since pre-caching by automatic download and storage of information is performed in accordance with specified download parameters that include at least one data source and at least one corresponding retrieval time and/or interval, the mobile communications device will include a means for monitoring the time. As noted above, to adapt the functionality of the mobile communications device to user preferences, the download parameters can be user-defined and entered by the user by means of a user interface. Such download parameters would usually include a user-defined schedule with information on at least one data source and at least one corresponding retrieval time. Accordingly, a mobile communication device will include download means for automatically downloading information depending on the download parameters stored therein. The schedule for downloading of information can be based on selected download times, such as every morning at 9:00 a.m. and at 9:30 a.m., or on selected time intervals, such as once every 15 minutes.

In another embodiment of the invention, the mobile communications device will include a control unit adapted to monitor user access to data sources and to generate an access profile based on such monitoring. The access profile will include address information of the data sources and corresponding access times and/or access frequency, which information will be stored in the devices memory. The device will provide for a download means that is adapted to download information based on the access profile. In this embodiment of the invention, pre-caching functionality can be provided without the user having to enter download parameters because the necessary download parameters are automatically generated from the user's access profile. The profile can, for instance, provide for a shorter pre-caching interval of an Internet WAP site if the site is frequently visited by the user.

Another aspect of the invention provides for a mobile communications device that has WAP functionality provided with application programming interfaces (APIs). This permits the new functionality of pre-caching WAP content according to user preferences to be implemented by means of software which uses existing APIs. Thus the invention provides for a digital storage medium, such as a microchip, that includes electronically readable control instructions that can be used to adapt an existing mobile communications device to execute the method described herein, when it is associated with a mobile communication device.

Although the present invention has been described in detail, those skilled in the art should understand that they can make various changes, substitutions and alterations herein without departing from the spirit and scope of the invention in its broadest form.

1. A method of storing and retrieving information with a mobile communications device, comprising:
automatically downloading information from a data source to a storage means coupled to said mobile communications device while connected to a communications network; and
retrieving said information from said storage means when said mobile communication device is disconnected from said communications network and displaying said information to a user.

2. The method as recited in claim 1 wherein said data source is the Internet.

3. The method as recited in claim 1 wherein said data source is pre-selected by said user.

4. The method as recited in claim 1 wherein said downloading information is of data in accordance with Wireless Application Protocol (WAP) standards.

5. The method as recited in claim 1 wherein said downloading information is at a plurality of pre-defined time intervals.

6. The method as recited in claim 1 wherein said downloading information is automatically performed on a user-defined schedule specifying at least one data source and at least one retrieval time.

7. The method as recited in claim 1 further comprising said downloading information is dependent on an access profile stored in said storage means, said access profile created by determining the data sources accessed by said user and basing said access profile on said data sources addresses and corresponding access times and/or access frequency.

8. A mobile communications device, comprising:
a means for storing download parameters, said parameters consisting of at least one data source and at least one retrieval time and/or interval;
a means for storing information downloaded from said data source when said mobile communications device is connected to a communications network; and
a means for a user to retrieve said stored information when said mobile communications device is not connected to a communications network.

9. The mobile communications device as recited in claim 8 further comprising said mobile communications device adapted to communicate with said communication network in accordance with GSM and/or UMTS standards.

10. The mobile communications device as recited in claim 8 further comprising a means for transmitting and/or receiving data with a packet switched service or with a packet data protocol addressed service selected from the group consisting of GPRS, HSCSD and/or EDGE.

11. The mobile communications device as recited in claim 8 further comprising a means for downloading data in accordance with Wireless Application Protocol (WAP) standards.

12. The mobile communications device as recited in claim 8 further comprising a means for monitoring time.

13. The mobile communications device as recited in claim 8 wherein said data source is the Internet.

14. The mobile communications device as recited in claim 8 wherein said download parameters are pre-selectable by said user.

15. The mobile communications device as recited in claim 8 wherein said download parameters consist of a user-defined schedule, said schedule consisting of information on at least one data source and at least one corresponding retrieval time.

16. The mobile communications device as recited in claim 8 further comprising download means for automatically downloading information based on said download parameters.

17. The mobile communications device as recited in claim 16 wherein said download means are adapted to download information at pre-defined time intervals.

18. The mobile communications device as recited in claim 8 further comprising:
a control unit adapted to monitor user access to data sources and generate and store an access profile based on address information of said data sources and corresponding access times and/or access frequency; and
a download means adapted to download information based on said access profile.

19. A mobile communications storage enabling device, comprising:
a digital storage medium of electronically readable control instructions to enable a mobile communications device, associable with said storage enabling device, to automatically download information from a data source to a storage means coupled to said mobile communications device, in accordance with predetermined parameters; and
a retrieval and display means to enable a user to recover said information from said storage means and display said information when said mobile communications device is disconnected from said communications network.

20. The mobile communications storage enabling device as recited in claim 19 wherein said digital storage medium is a microchip.
